(19) United States
(12) Patent Application Publication
(10) Pub. No.: US 2015/0191585 A1
(43) Pub. Date: Jul. 9, 2015

(54) ELASTOMER COMPOSITIONS COMPRISING GAS-TO-LIQUID BASE OILS AND PROCESSES FOR PREPARATION THEREOF

(71) Applicants: SHELL INTERNATIONALE RESEARCH MAATSCHAPPIJ B.V., The Hague (NL); SHELL OIL COMPANY, Houston, TX (US)

(72) Inventor: Volker Klaus Null, Hamburg (DE)

(21) Appl. No.: 14/366,462

(22) PCT Filed: Dec. 21, 2012
(86) PCT No.: PCT/EP2012/076796

§ 371 Date: Jun. 18, 2014

(30) Foreign Application Priority Data
Dec. 22, 2011 (EP) 11195303.0

(51) Int. Cl. C08L 7/00; C08L 9/06; C08L 9/00

(52) U.S. Cl. CPC C08L 7/00; C08L 9/00; C08L 9/06

(57) ABSTRACT

Elastomer compositions comprising a gas-to-liquid (GTL) derived synthetic base oil as an extender oil are provides, wherein the base oil has not been subjected to a process for the removal of haze causing components. Elastomers described include those comprising one elastomer component, such as a rubber, and a base oil wherein the base oil has not been treated to remove haze components and is present in the range of from about 0.1 wt % to about 50 wt % based on the weight of the total elastomer composition. The haze components may include paraffinxc microcrystalline wax formed as part of the GTL process.

The invention relates to the use of base oils as extender oils in elastomer production. In particular, the invention relates to the use of gas-to-liquid (GTL) derived base oils as elastomer extender oils.

As reserves of easily accessible oil become more scarce there has been an increasing trend to look towards other sources of hydrocarbons in order to meet current needs for petrochemical products. It has been known to utilise GTL technology in order to convert natural gas into heavier hydrocarbons, typically via a Fischer Tropsch synthesis reaction. Natural gas is abundant in a number of locations around the world that are easily accessible and, as a result, it represents a promising starting point for hydrocarbon conversion to desirable petrochemical products.

High viscosity base oils derived from GTL synthesis often show a hazy appearance that is typically due to the presence of a small quantity of microcrystalline wax particles. There has been a desire in the art to assume that such oils are unsuitable some applications including use as elastomer extender oils. In general, there is an overwhelming tendency to favour bright clear oils due to the perception that these are somehow purer and less likely to include contaminants that will affect the performance characteristics of the oil. Indeed, this conventional view is particularly entrenched with regards to oils with a high viscosity and high pour point. In particular, there has been a tendency to include additional dewaxing and distillation steps when refining such base oils in order to obtain substantially haze-free bright stock oils. It is only these haze-free clear and bright base oils that have been considered as suitable for use in a wide range of applications including as lubricants and also as elastomeric extender oils.

US2009/203835 describes a process to prepare a blend of a mineral derived residual and de-asphalted oil component, the blend as obtainable, a cylinder oil composition comprising said oil blend, and to the use of the oil blend as a process oil for various processes.

WO2010/125144 describes functional fluid compositions which are useful as hydraulic fluids and shock absorber fluids and which have improved seal swell properties.

WO2010/094681 describes the use of a lubricating composition comprising a Fischer-Tropsch derived base oil and one or more additives for particular use in the crankcase of an internal combustion engine, in particular a diesel engines such as a heavy duty diesel engine.

WO-A-2005/063940 describes a process for the preparation of a Fischer-Tropsch wax derived haze free base oil having a kinematic viscosity at 100° C. of greater than 10 cSt. WO-A-2005/063940 includes additional processing intended to reduce the wax content of a Fischer-Tropsch synthesis product that has been subjected to hydroisomerisation (catalytic cracking) and distillation to remove lighter fuel products by undertaking additional hydroisomerisation and solvent dewaxing steps.

WO-A-03033622 describes a process wherein a haze free base oil is prepared from a Fischer-Tropsch product by removing the heaviest fraction, containing the haze precursors, by a deep-cut distillation performed at a cut-off temperature of between 1150 and 1350° F. (621-732° C.). This is not only a technically difficult distillation step it also removes valuable heavy base oil molecules in addition to the haze precursors.

A disadvantage of the processes described in the art is that the processing of Fischer Tropsch synthesis products is extended considerably in order to produce conventional haze-free clear and bright base oils that are regarded as suitable for use, for example, as elastomer extender oils and in particular as extender oils for synthetic rubbers. The cost of production of GTL-derived base oils can be relatively high rendering them less suitable for use as extender oils compared to mineral oil equivalents.

Elastomer extender oil compositions are added to natural and synthetic elastomers, including rubbers, for a number of reasons, for example to reduce the mixing temperature required during processing and to prevent the scorching of the rubber polymer when it is being ground, to decrease the viscosity of the rubber to improve the general workability of the rubber compound, to aid in the dispersion of fillers, as well as to modify the physical properties of the rubber compound.

It is an object of the present invention to reduce the overall cost and complexity of production of GTL-derived base oils. In particular, it is an object of the invention to reduce the cost of producing elastomers that comprise GTL-derived base oils as extender oils.

Unexpectedly it has been found by the inventors that, contrary to the prevailing belief in the art, GTL-derived base oils comprising haze components can be used as extender oils in production of elastomers without the need to first remove the haze components. In particular, it has been found that elastomers comprising the GTL-derived base oils as extenders, and that have not been subjected to haze-removal, are not inferior to comparative elastomers comprising bright stock base oils and is some cases will perform better.

In a first aspect the invention provides an elastomer composition that comprises GTL-derived base oil, which GTL-derived base oil has not been subjected to a process for the removal of haze components. Suitably, the GTL-derived base oil comprises a Fischer Tropsch synthesis product.

In another embodiment of the invention, there is provided an elastomer composition comprising at least one elastomer component, and a GTL-derived extender oil, wherein the GTL-derived extender oil has not been treated to remove haze components. Typically the base oil comprises a wax component that is present in the range of from at least about 0.001 wt % to at most about 5 wt %, typically at most about 1 wt %, suitably at most no more than 0.1 wt % based on the total weight of the base oil.

Suitably the GTL-derived extender oil comprises a GTL-derived base oil that includes at least some paraffinic wax content—i.e. sufficient microcrystalline wax content to render the appearance of the base oil at least partially opaque (hazy) at room temperature and pressure.

In yet another embodiment of the invention, an elastomer composition is provided comprising:

a) at least one elastomer, elastomer component, or mixtures thereof,
b) an extender oil comprising a GTL-derived base oil that includes a microcrystalline wax content, the extender oil present in the range of from at least about 0.1 wt % to at most about 50 wt % based on the total weight of the elastomer composition, and optionally at least one component selected from:
c) reinforcing agents,
d) cross-linking agents and/or cross-linking auxiliaries,
e) inorganic fillers, and
f) waxes and/or antioxidants.

A further aspect of the invention provides for a process for the manufacture of an elastomer composition comprising combining at least one elastomer, elastomer component, or a mixture thereof with an extender oil, the extender oil comprising a GTL-derived base oil that includes a haze-causing paraffinic microcrystalline wax content, the extender oil present in the range of from at least about 0.1 wt % to at most about 50 wt % based on the total weight of the elastomer composition, suitably at least about 5 wt % and at most around 20 wt %, more suitably up to at least 15 wt %. Alternatively, the extender oil may be included at a relative amount of at least 0.2 to at most 100 parts per hundred of rubber (PHR).

The GTL-derived base oil as used in the invention can be a Fischer-Tropsch synthesis product obtained by well-known processes, for example the so-called Sasol process, the Shell Middle Distillate Process or by the ExxonMobil “AGC-21” process. These and other processes are for example described in more detail in EP-A-776959, EP-A-668342, U.S. Pat. No. 4,943,672, U.S. Pat. No. 5,059,299, WO-A-9934917 and WO-A-9920720.

More preferably the Fischer-Tropsch synthesis product comprises at least 30 wt %, preferably at least 50 wt %, and more preferably at least 55 wt % of compounds having at least 30 carbon atoms. Furthermore the weight ratio of compounds having at least 60 or more carbon atoms and compounds having at least 30 carbon atoms of the Fischer-Tropsch product is at least 0.2, preferably at least 0.4 and more preferably at least 0.55.

Preferably the Fischer-Tropsch product comprises a C₂₀+ fraction having an ASF-alpha value (Anderson-Schulz-Flory chain growth factor) of at least 0.925, preferably at least 0.935, more preferably at least 0.945, even more preferably at least 0.955.

The initial boiling point of the Fischer-Tropsch product may range up to 400° C., but is preferably below 200° C. Preferably any compounds having 4 or less carbon atoms and any compounds having a boiling point in that range are separated from a Fischer-Tropsch synthesis product before the Fischer-Tropsch synthesis product is used in said hydroisomerisation step.

Such a Fischer-Tropsch product can be obtained by any process, which yields a relatively heavy Fischer-Tropsch product. However, not all Fischer-Tropsch processes yield such a heavy product. An example of a suitable Fischer-Tropsch process is described in WO-A-9934917 and in AU-A-698392. These processes may yield a Fischer-Tropsch product as described above.

The Fischer-Tropsch product will contain no or very little sulphur and nitrogen containing compounds. This is typical for a product derived from a Fischer-Tropsch reaction, which uses synthesis gas containing almost no impurities. Sulphur and nitrogen levels will generally be below the detection limits, which are currently 5 ppm for sulphur and 1 ppm for nitrogen.

The waxy synthesis product of Fischer Tropsch reaction is typically subjected to a hydrocracking/hydroisomerisation reaction that is suitably performed in the presence of hydrogen and a catalyst, which catalyst can be chosen from those known to one skilled in the art as being suitable for this reaction. Catalysts for use in the hydroisomerisation typically comprise an acidic functionality and a hydrogenation/dehydrogenation functionality. Preferred acidic functionality's are refractory metal oxide carriers. Suitable carrier materials include silica, alumina, silica-alumina, zirconia, titania and mixtures thereof. Preferred carrier materials for inclusion in the catalyst for use in the process of this invention are silica, alumina and silica-alumina. A particularly preferred catalyst comprises platinum supported on a silica-alumina carrier. Preferably the catalyst does not contain a halogen compound, such as for example fluorine, because the use of such catalysts require special operating conditions and involve environmental problems. Examples of suitable hydrocracking/hydroisomerisation processes and suitable catalysts are described in WO-A-0014179, EP-A-532118, EP-A-666894 and the earlier referred to EP-A-776959.

Preferred hydrogenation/dehydrogenation functionality's are Group VIIIB metals, for example cobalt, nickel, palladium and platinum and more preferably platinum. In case of platinum and palladium the catalyst may comprise the hydrogenation/dehydrogenation active component in an amount of from 0.005 to 5 parts by weight, preferably from 0.02 to 2 parts by weight, per 100 parts by weight of carrier material. In case nickel or cobalt is used a higher content will be present, optionally nickel is used in combination with copper. A particularly preferred catalyst for use in the hydroconversion stage comprises platinum in an amount in the range of from 0.05 to 2 parts by weight, more preferably from 0.1 to 1 parts by weight, per 100 parts by weight of carrier material. The catalyst may also comprise a binder to enhance the strength of the catalyst. The binder can be non-acidic. Examples are clays and other binders known to one skilled in the art.

In the hydroisomerisation the feed is contacted with hydrogen in the presence of the catalyst at elevated temperature and pressure. The temperatures typically will be in the range of from 175 to 380° C., preferably higher than 250° C. and more preferably from 300 to 370° C. The pressure will typically be in the range of from 10 to 250 bar and preferably between 20 and 80 bar. Hydrogen may be supplied at a gas hourly space velocity of from 100 to 10000 Nl/1/hr, preferably from 500 to 5000 Nl/l/hr. The hydrocarbon feed may be provided at a weight hourly space velocity of from 0.1 to 5 kg/l/hr, preferably higher than 0.5 kg/l/hr and more preferably lower than 2 kg/l/hr. The ratio of hydrogen to hydrocarbon feed may range from 100 to 5000 Nl/kg and is preferably from 250 to 2500 Nl/kg.

The conversion in the hydroisomerisation as defined as the weight percentage of the feed boiling above 370° C. which reacts per pass to a fraction boiling below 370° C., is at least 20 wt %, preferably at least 25 wt %, but preferably not more than 80 wt %, more preferably not more than 70 wt %. The feed as used above in the definition is the total hydrocarbon feed fed to the hydroisomerisation, thus also any optional recycle step.

One or more distillate separations may be performed on the effluent of the hydroisomerisation reaction to obtain at least one middle distillate fuel fraction and heavier hydrocarbon bottoms referred to as the residue. The residue as obtained in such a distillation is optionally subjected to a further distillation performed at near vacuum conditions. This bottom product or residue preferably boils for at least 95 wt % above 370° C. The vacuum distillation is suitably performed at a pressure of between at least 0.001 and at most 0.1 bara. The residue is obtained as the bottom product of such a vacuum distillation. The 10 wt % recovery boiling point of the residue is typically between 350 and 550° C.

The wax content of the residue is low to start with although it is sufficient to impart a hazy appearance to base oils derived from the residue. The wax content of the residue can be measured according to the following procedure. 1 weight part of the to be measured oil fraction is diluted with 4 parts of a (50/50 vol/vol) mixture of methyl ethyl ketone and toluene, which is subsequently cooled to −20° C. in a refrigerator. The mixture is subsequently filtered at −20° C. The wax is thoroughly washed with cold solvent, removed from the filter, dried and weighed. If reference is made to a wax content as a wt % value is meant the percentage of the total oil which is made up of wax.

According to convention the residue would be processed further using any suitable hydroconversion process, which is intended to further reduce the wax content of the residue. The hydroconversion process would typically include special dewaxing catalysts that comprise a molecular sieve optionally in combination with a metal having a hydrogenation function. A minimal amount of wax is required in order to operate additional solvent dewaxing steps in an optimal manner. Solvent dewaxing is well known to those skilled in the art and involves admixture of one or more solvents and/or wax precipitating agents with the base oil precursor fraction and cooling the mixture to a temperature in the range of from −10° C. to −40° C., to separate the wax from the oil. The oil containing the wax is usually then filtered so as to produce a fully de-hazed final bright stock oil. Examples of these and other suitable solvent dewaxing processes are described in Lubricant Base Oil and Wax Processing, Avilino Sequeira, Jr, Marcel Dekker Inc., New York, 1994, Chapter 7.

Under the present invention GTL base oils (i.e. base oils obtained from a Fischer Tropsch synthesis reaction) that comprise haze causing components—such as wax—do not require extensive further processing via methods such as those described. Instead it has been found that the haze causing components do not contribute substantially to a reduction of performance of base oils in applications such as for use as elastomer extender oils

Haze causing components present within the base oils utilised in the present invention typically comprise a soft microcrystalline wax component that has a congealing point as determined by ASTM D 938 of between 85 and 120° C. and more preferably between 95 and 120° C. and a PEN at 43° C. as determined by IP 376 (determination of needle penetration of petroleum wax) of more than 0.8 mm and preferably more than 1 mm. The wax is further characterized in that it is predominantly paraffinic in nature and preferably comprises less than 1 wt % aromatic compounds and less than 10 wt % naphthenic compounds, more preferably less than 5 wt % naphthenic compounds. The mol percentage of branched paraffins in the wax is typically above 33 and more preferably above 45 and below 80 mol % as determined by C¹³ NMR. This method determines an average molecular weight for the wax and subsequently determines the mol percentage of molecules having a methyl branch, the mol percentage of molecules having an ethyl branch, the mol percentage of molecules having a C₃ branch and the mol percentage having a C₄₊ branch, under the assumption that each molecule does not have more than one branch. The mol % of branched paraffins is the total of these individual percentages. This method calculated the mol % in the wax of an average molecule having only one branch. In reality paraffin molecules having more than one branch may be present. Thus the content of branched paraffins determined by different method may result in a different value.

Conventional haze-free base oils, including bright stock oils, will usually have a kinematic viscosity at 100° C. of above 10 cSt which viscosity may range up to 40 cSt and above. Kinematic viscosity may be determined at 40 and 100° C. by standard methods including ASTM D445. The pour point is typically below −5° C. and even more usually below −21° C. The viscosity index is suitably above 120 and usually above 130. A haze free base oil can also be determined by its cloud point: as determined by ASTM D2500 of near the pour point and below 0° C., usually below −10° C.

Hazy GTL base oils of the present invention are defined as a Fischer Tropsch derived oil having a carbon chain length of typically greater than C₂₀₊ and comprising a wax component of between at least around 0.001 wt % and at most around 5 wt %, typically at most no more than around 1% wt, suitably at most no more than 0.1 wt %. The hazy GTL-derived base oils of the invention are visibly at least partially or completely opaque at ambient temperature. Hence, it will be apparent to the skilled person that the base oils utilised in the present invention comprise sufficient additional heavy components (such as wax) to impart a visible haze to the appearance of the oil. As such, the base oils of the present invention would not be described conventionally as ‘clear’ or ‘bright’. Hazy base oils of the invention will typically be rendered clear and bright upon heating to temperatures in excess of 50° C.

In a specific embodiment of the present invention, the GTL derived base oil is defined as a heavy base oil component comprising carbons of up to around C₄₀, typically in the range of between at least C₂₀ and at most C₄₀, as well as haze causing components. The base oil of the invention typically has a kinematic viscosity at 40° C. in excess of at least 80 mm²/s, suitably in excess of at least 100 mm²/s. The base oil of the invention typically has a kinematic viscosity at 100° C. in excess of at least of at least 10 mm²/s, suitably in excess of at least 15 mm²/s, optionally up to around 35 mm²/s. Hence, the invention provides advantageously for the use of so-called extra-heavy hazy base oils as extender oils for elastomer compositions.

In a further specific embodiment of the invention, a GTL derived hazy heavy base oil suitable for use as a elastomer, synthetic rubber extender oil is characterised by a kinematic viscosity at 40° C. of 151 mm²/s and at 100° C. of 19 mm²/s; a cold pour point of −24° C. and a density at 15° C. of around 837 kg/m³.

An embodiment of the invention provides an elastomer composition comprising:

a) at least one elastomer, elastomer component, or mixtures thereof,
b) an extender oil comprising a GTL-derived base oil that includes a microcrystalline wax content, the extender oil present in the range of from at least about 0.1 wt % to at most about 50 wt % based on the total weight of the elastomer composition, and optionally at least one component selected from:
c) reinforcing agents,
d) cross-linking agents and/or cross-linking auxiliaries,
e) inorganic fillers, and
f) waxes and/or antioxidants.

Suitably the elastomer is a rubber, optionally selected from elastomers comprising any of the following, including combinations—i.e. copolymers—thereof:
Natural rubber (NR)
Isoprene rubber, polyisoprene (IR)
Styrene-butadiene-rubber (SBR)
Butadiene rubber (BR)
Butylene rubber (IIR)
Ethylene-propylene diene rubber (EPDM)
Ethylene-propylene rubber (EPM)
Nitrile butadiene rubber (NBR)
Chloroprene rubber (CR)

In examples of the invention in use the elastomer is a thermoplastic elastomer (TPE) or an ethylene propylene diene monomer (EPDM) rubber. Typically TPEs include styrenic block copolymers, polyolefin blends, elastomeric alloys, thermoplastic polyurethanes, thermoplastic copolyesters and thermoplastic polyamides.

Other compounding agents used in the rubber industry, such as tackifiers, vulcanization controlling agents, high loss-providing agents and low loss-providing agents, may also be optionally included in the rubber composition.

Examples of reinforcing agents are carbon black and silica. Examples of cross-linking agents and cross-linking auxiliaries are organic peroxides, sulfur and organic sulfur compounds as cross-linking agents, and thiazole compounds and guanidine compounds as the cross-linking auxiliaries. Examples of inorganic fillers are calcium carbonate, magnesium carbonate, clay, alumina, aluminium hydroxide, mica and the like. Any suitable waxes and/or antioxidants may be incorporated in order to prevent or reduce degradation.

The method of making the elastomer composition of the present invention comprises the blending of the components of the elastomer composition, components a) to f), in any order. The conditions used in the preparation of the elastomer and rubber compositions of the present invention are known to those skilled in the art.

A specific embodiment of the present invention provides a process for the manufacture of an elastomer composition comprising combining at least one elastomer, elastomer component, or a mixture thereof with an extender oil, the extender oil comprising a GTL-derived base oil that includes a paraffinic wax content, the extender oil present in the range of from at least about 0.1 wt % to at most about 50 wt % based on the total weight of the elastomer composition (equivalent to 0.2 to 100 parts per hundred rubber); and wherein the base oil includes a microcrystalline wax content of between at least about 0.001 wt % and at most about 5 wt %.

A specific embodiment of the invention also provides for a process for the manufacture of an elastomer product comprising obtaining an elastomer composition according to the process described above, and forming a product from the elastomer composition. The elastomers of the invention may be formed, moulded, rolled, pressed or cut by conventional methods in order to produce an elastomer containing product. The elastomers produced according to the methods of the invention may be formed into a wide variety of products, as will be appreciated by the skilled person including—but not limited to—tyres, elastomer sheeting, washers, o-rings, construction materials, fabrics, coatings, seals, tubing, electrical insulation, membranes, mechanical products, dampers, and clothing.

The invention will be illustrated with the following non-limiting examples.

### EXAMPLES

A GTL-derived hazy heavy base oil of the invention (denoted as oil 4) was used in the production of TPE and EPDM synthetic rubber compositions as described below. For comparison three bright stock base oils were also used (see Table 1). The first comparison oil (oil 1) is a GTL-derived base oil which has been subjected to dewaxing in order to render a clear and bright GTL derived base oil. Two technical white oils of mineral origin (oils 2 and 3) have been used. In particular, oil 3 was used for comparison as it displays very similar kinematic viscosity at 100° C. to that of oil 4.

In a colour stability test samples of oils 1, 2 and 4 (40 g in a pour point method glass and covered by a watch glass) were graded for their apparent colour according to ASTM 1500 and then maintained at a temperature of 150° C. for 20 hours. The results of the test are shown in Table 2. The GTL-derived oils 1 and 4 did not show any appreciative change in colour, whereas mineral derived oil 2 showed a considerable change in colour. This indicates that mineral derived oils are less suited to inclusion in elastomer compositions where temperature stability of colour is an important factor. For example, polymers and elastomers used in automotive interiors—including upholstery and dashboard coatings—must show long term colour stability over a range of temperatures in order to avoid the appearance of staining or marking.

TABLE 1
Properties of extender oils used in Examples

| | | | Oil 2 | Oil 3 | |
|---|---|---|---|---|---|
| | | Oil 1 | Mineral - | Mineral - | Oil 4 |
| | | GTL - | technical | technical | GTL - |
| Origin | | dewaxed | white oil | white oil | hazy |
| Density at | kg/m³ | 816 | 856 | 889 | 837 |
| 15° C. - | | | | | |
| ASTM D4052, | | | | | |
| ASTM D1298 | | | | | |
| Kinematic | mm²/s | 17 | 17 | 238 | 151 |
| Viscosity | | | | | |
| 40° C. - | | | | | |
| ASTM D445 | | | | | |
| Kinematic | mm²/s | 4 | 3.7 | 19.8 | 19 |
| Viscosity | | | | | |
| 100° C. - | | | | | |
| ASTM D445 | | | | | |
| Pour Point - | ° C. | −30 | −18 | −9 | −24 |
| ASTM D97 | | | | | |
| Flame Point | ° C. | >200 | 190 | 270 | >240 |
| (COC method) - | | | | | |
| ASTM D92 | | | | | |

TABLE 2
Colour stability test (ASTM D1500)

| | Oil 1* | Oil 2* | Oil 4* |
|---|---|---|---|
| fresh oil before test | <0.5 | <0.5 | <0.5 |
| after test (20 h @ 150° C.) | <0.5 | 4 | <0.5 |

*Units are in ASTM color values according to ASTM D1500

TPE compositions were prepared comprising the hazy base oil of the invention and the comparative oils. The TPE formulations were of conventional type and are set out in Table 3. The quantities of the components are given as per hundred rubber (PHR) values which is conventional in the art (see page 2, Part 1.2, Rubber Technology: Compounding and Testing for Performance, R. A. Annicelli, Hanser Verlag, 2001) with the total value of the elastomer (rubber) being the sum total of natural and styrene butadiene rubber (SBR) components shown.

The TPE elastomers prepared as Examples 1-4 were subjected to a variety of industry standard tests for hardness, tear strength and resistance and deformation as set out in Table 4. Unexpectedly, the TPE elastomer of the invention (as shown in Example 4) performs comparatively with the other elastomers of Examples 1-3 which comprise conventional clear and bright extender oils. In fact in some tests it can be seen that the elastomer of Example 4 even outperforms the conventional elastomers.

Hence, it can be concluded that contrary to the accepted view, the presence of microcrystalline wax in hazy GTL-derived base oils does not lead to impairment or a reduction in the properties of TPE elastomers that contain said oils as extenders.

TABLE 3
Thermoplastic elastomer (TPE) formulation

| | | Example 1* | Example 2* | Example 3* | Example 4 |
|---|---|---|---|---|---|
| Formulation | Generic Description | PHR | PHR | PHR | PHR |
| NK Orange | Natural rubber | 50% | 50% | 50% | 50% |
| KER 1502 | SBR Rubber | 50% | 50% | 50% | 50% |
| Durafill 200 | Precipitated silica | 50% | 40% | 40% | 40% |
| Mikrofein Kreide | Chalk | 30% | 30% | 30% | 30% |
| Base Baryt BB 185 | Barium sulfate | 100% | 101% | 101% | 101% |
| Sinar FA 1865 | Stearic acid 65% | 2% | 2% | 2% | 2% |
| Extender oil | Oil 1 | 51% | — | — | — |
| Extender oil | Oil 2 | — | 51% | — | — |
| Extender oil | Oil 3 | — | — | 51% | — |
| Extender oil | Oil 4 | — | — | — | 51% |
| Cristal 134 | Titanium dioxide | 5% | 5% | 5% | 5% |
| 3611 -SBR-Batch | SBR with 33% carbon black | 1% | 2% | 2% | 2% |
| Zinkw. Goldsiegel RQ3 | Zinc oxide | 4% | 4% | 4% | 4% |
| Perkacit MBTS pdr-d | 2,2′-DITHIOBIS(BENZOTHIAZOLE) | 1% | 1% | 1% | 1% |
| Accelerator CBS | Benzothiazyl-2-cyclothexyl | 2% | 2% | 2% | 2% |
| | sulphenamide | | | | |
| 5240 Batch | Sulfur | 3% | 3% | 3% | 3% |

PHR = per hundred rubber
*Comparative examples

TABLE 4
Results of TPE performance

| Test | Method | Unit | Example 1* | Example 2* | Example 3* | Example 4 |
|---|---|---|---|---|---|---|
| Hardness - Shore A | DIN 53505 | SHE | 45 | 43 | 40 | 43 |
| Tear Resistance | DIN 53504 | N/mm² | 5.8 | 5.7 | 6.0 | 6.4 |
| Elongation at Break | DIN 53504 | % | 512 | 516 | 510 | 533 |
| Tear strength/unit length | DIN ISO 34-1 | N/mm | 2.6 | 2.2 | 2.1 | 2.1 |
| deformation standard value | VW-PV 3307 | % | 69 | 71 | 71 | 69 |
| low temperature standard value | DIN 53513 | ° C. | −47 | −50 | −41 | −40 |

*Comparative examples

EPDM compositions were prepared comprising the hazy base oil of the invention and the comparative oils. The EPDM formulations were of conventional type and are set out in Table 5. The quantities of the components are given as parts per hundred rubber (PHR) values, with the total value of the elastomer (rubber) being the sum total of ethylene propylene diene terpolymer and ethylene propylene diene rubber with ethylidene norbornene as diene component. Dicyclopentadiene or vinyl nobernene are also suitable diene components for EPDM rubbers in general.

The EPDM elastomers prepared as Examples 5-8 were subjected to a variety of industry standard tests for hardness, tear strength and resistance and deformation as set out in Table 6. Compared to the TPE testing regimen set out in Table 4, additional high temperature immersion tests were also carried out on the EPDM polymers of Examples 5-8. Unexpectedly, the EPDM elastomer of the invention (as shown in Example 8) performs comparatively with the other elastomers of Examples 5-7 which comprise conventional clear and bright extender oils. In fact in some tests it can be seen that the elastomer of Example 8 even outperforms the conventional elastomers.

Hence, it can be concluded that contrary to the accepted view, the presence of microcrystalline wax in hazy GTL-derived base oils does not lead to impairment or a reduction in the properties of EPDM elastomers that contain said oils as extenders.

TABLE 5
ethylene propylene diene monomer (EPDM) rubber formulation

| | | Example 5* | Example 6* | Example 7* | Example 8 |
|---|---|---|---|---|---|
| Formulation | Generic description | PHR | PHR | PHR | PHR |
| Vistalon 3666 (EPDM) | Ethylene Propylene Diene Terpolymer Rubber | 54% | 54% | 54% | 54% |
| Buna EPG 8450 | Ethylene Propylene Diene Rubber with Ethylidene | 46% | 46% | 46% | 46% |
| | Norbornene as Diene Component | | | | |
| Purex HS 25 | Carbon black | 23% | 23% | 23% | 23% |
| DX 0/35 | Soot/carbon black | 65% | 65% | 65% | 65% |
| Extender oil | Oil 1 | 15% | — | — | — |
| Extender oil | Oil 2 | — | 15% | — | — |
| Extender oil | Oil 3 | — | — | 15% | — |
| Extender oil | Oil 4 | — | — | — | 15% |
| Struktol WS 180 | Condensation product of fatty acid derivatives | 0% | 0% | 0% | 0% |
| | and silicones | | | | |
| Pluriol E 4000 | Polyethyleneglycol | 2% | 2% | 2% | 2% |
| Vulcanox HS/LG | 2,2,4-trimethyl-1H-quinoline | 1% | 1% | 1% | 1% |
| LUV N 50 | Magnesium oxide | 3% | 3% | 3% | 3% |
| Kettlitz VP 4185 | Trimethylolpropantrimethacrylat 70% on silica | 1% | 1% | 1% | 1% |
| Trigonox 101-45 B GR | 2,5-Dimethyl-2,5-di(tert-butylperoxy)hexane | 6% | 6% | 6% | 6% |

PHR = per hundred rubber
*Comparative examples

TABLE 6
Results of EPDM performance

| Results | Method | Unit | Example 5* | Example 6* | Example 7* | Example 8 |
|---|---|---|---|---|---|---|
| Hardness Shore A | DIN 53505 | SHE | 66 | 66 | 67 | 67 |
| Tear Resistance | DIN 53504 | N/mm² | 10.7 | 10.3 | 10.9 | 10.5 |
| Elongation at Break | DIN 53504 | % | 379 | 377 | 380 | 351 |
| Tear strength/unit length | DIN ISO 34-1 | N/mm | 6.8 | 7.1 | 7.5 | 7.3 |
| deformation standard value | VW-PV 3307 | % | 23 | 28 | 26 | 24 |
| low temperature standard value | DIN 53513 | ° C. | −56 | −53 | −51 | −52 |
| Hardness Shore A - 94 hrs at 130° C., immersion in | DIN 53505 | SHE | 44 | 42 | 44 | 44 |
| 80* Lubrizol OS 206304 | | | | | | |
| Tear Restistance - 94 hrs at 130° C., immersion in | DIN 53504 | N/mm² | 7.7 | 7.9 | 7.7 | 8.3 |
| 80* Lubrizol OS 206305 | | | | | | |
| Elongation at Break - 94 hrs at 130° C., immersion | DIN 53504 | % | 221 | 261 | 224 | 237 |
| in 80* Lubrizol OS 206306 | | | | | | |
| Swelling - 94 hrs at 130° C., immersion in 80* | ASTM D471-98 | % | 54.7 | 56.4 | 53.6 | 53.7 |
| Lubrizol OS 206307 | | | | | | |

*Comparative examples

All references cited herein are incorporated by reference in their entirety. Unless otherwise defined, all technical and scientific terms used herein have the same meaning as commonly understood by one of ordinary skill in the art to which this invention belongs.

Although particular embodiments of the invention have been disclosed herein in detail, this has been done by way of example and for the purposes of illustration only. The aforementioned embodiments are not intended to be limiting with respect to the choice of elastomer or the scope of the appended claims, which follow. It is contemplated by the inventors that various substitutions, alterations, and modifications may be made to the invention without departing from the spirit and scope of the invention as defined by the claims.

1. An elastomer composition comprising a gas-to-liquid (GTL) derived synthetic base oil as an extender oil, wherein the base oil has not been subjected to a process for the removal of haze components.

2. The elastomer of claim 1, wherein base oil comprises a Fischer Tropsch reaction synthesis product.

3. The elastomer of claims 1 or 2 comprising at least one elastomer component, and a base oil, wherein the base oil has not been treated to remove haze components and is present in the range of from about 0.1 wt % to about 50 wt % based on the weight of the total elastomer composition.

4. The elastomer of any of claims 1 to 3, wherein the elastomer is a rubber.

5. An elastomer composition comprising:
a) at least one elastomer, elastomer component, or mixtures thereof,
b) an extender oil comprising a GTL-derived base oil that includes a microcrystalline wax content, the extender oil present in the range of from at least about 0.1 wt % to at most about 50 wt % based on the weight of the elastomer composition, and optionally at least one further component selected from:
c) reinforcing agents,
d) cross-linking agents and/or cross-linking auxiliaries, e) inorganic fillers, and
e) waxes and/or antioxidants.

6. The elastomer of claims 1 to 5, wherein the elastomer comprises a thermoplastic elastomer (TPE).

7. The elastomer of claim 6, wherein the TPE is selected from the group consisting of styrenic block copolymers, polyolefin blends, an elastomeric alloy, thermoplastic polyurethanes, thermoplastic copolyester and thermoplastic polyamides.

8. The elastomer of claims 1 to 5, wherein the elastomer comprises one or more of the group selected from natural rubber (NR); isoprene rubber or polyisoprene (IR); styrene-butadiene-rubber (SBR); butadiene rubber (BR); butylene rubber (IIR); an ethylene-propylene diene rubbermonomer (EPDM); ethylene-propylene rubber (EPM); nitrile butadiene rubber (NBR); and chloroprene rubber (CR).

9. The elastomer of claim 8, wherein the elastomer comprises a co-polymer.

10. The elastomer any of claims 5 to 9, wherein the base oil includes a paraffinic wax content of between 0.001 wt % and 5 wt %.

11. Use of a GTL-derived base oil that includes a paraffinic wax content as an extender oil in the manufacture of an elastomer composition.

12. The use of claim 11, wherein the microcrystalline wax content is between at least 0.001 wt % and at most 5 wt %.

13. A process for the manufacture of an elastomer composition comprising combining at least one elastomer, elastomer component, or a mixture thereof with an extender oil, the extender oil comprising a GTL-derived base oil that includes a paraffinic wax content sufficient to render the appearance of the GTL-derived base oil as hazy at ambient temperature, the extender oil present in the range of from at least about 0.1 wt % to at most about 50 wt % based on the total weight of the elastomer composition.

14. The process of claim 13, wherein the, and wherein the base oil includes a microcrystalline wax content is of between at least 0.001 wt % and at most 5 wt % of the total weight of the GTL-derived base oil.

15. A process for the manufacture of an elastomer product comprising obtaining an elastomer composition according to the process of claims 13 and 14, and forming a product from the elastomer composition.
